(19) United States
(12) Patent Application Publication
(10) Pub. No.: US 2013/0173339 A1
(43) Pub. Date: Jul. 4, 2013

(54) FOOD MANAGEMENT SERVICES

(71) Applicant: KITCHOLOGY LLC, Newark, DE (US)

(72) Inventors: Alain C. Briancon, Poolesville, MD (US); Iris S. Sherman, Kennebunk, ME (US); Michele A. Drgon, Stuart, FL (US); Chris A. Giacoponello, Pottstown, PA (US); Ellen S. Foreman, State Collage, PA (US); Howard E. Goldberg, Wynnewood, PA (US); Marc D. Feldman, Kennebunkport, ME (US); Ian T. Durham, Kennebunk, ME (US)

(73) Assignee: KITCHOLOGY LLC, Newark, DE (US)

(21) Appl. No.: 13/730,265

(22) Filed: Dec. 28, 2012

Related U.S. Application Data
(60) Provisional application No. 61/581,934, filed on Dec. 30, 2011.

(51) Int. Cl. G06Q 30/02

(52) U.S. Cl. CPC G06Q 30/0201
USPC 705/7.29

(57) ABSTRACT

A food chain procurement and consumption management service tailored to support consumer specific goals that may evolve and be altered over time. While described in terms of the preferred embodiment, the system for procurement and consumption management may be adapted to encompass products and services that are not food specific.

### CROSS REFERENCE TO RELATED APPLICATION

This application claims the benefit of U.S. provisional application No. 61/581,934, filed Dec. 30, 2011, which is incorporated herein by reference as if fully set forth.

### FIELD

This application relates to providing assistance to consumers to support their food choices and restrictions in an interactive manner.

### BACKGROUND

Many consumers need to comply with some level of food restriction as a result of medical conditions. In the US only, food allergies affect 14 million households; food intolerance 30 million; Celiac/Coeliac 4 million; Asthma 26 million; and autoimmune and diabetes 47 million households. These restrictions impact the quality of life and joy associated with food activities by creating barriers to unrestricted shopping choices. For example, by forcing careful analysis of ingredients of food from food labels, and thus longer shopping trips, restructured recipes to accommodate different members of household, etc.

Many consumers focus on sustainability issues such as shopping for organic food, local food, chemical free foods, or more efficient consumption and reduced food waste. Many consumers express preferences, such as having a non-medical preference for a no starch diet, but may not consistently follow their preferences. For both types of consumers, the ability to screen their food activities in an efficient, adaptive manner is critical.

### SUMMARY

In an aspect, the invention relates to a method of providing food management services. The method may include offering one or more incentives for prospective consumers to register with a provider of food management services, receiving a request at the provider of food management services from a consumer to register with the provider of food management services to receive at least one of the offered incentives, registering the consumer with the provider of food management services to create a registered consumer, assigning a unique identifier to the registered consumer, assigning permission granted to one or more recording devices of the registered consumer that is connected to a network to record food activities of the registered consumer using the unique identifier at the provider of food management services, enabling one or more applications on said one or more of the registered consumer recording device to generate unique transaction identifiers to record food activity information of the registered consumer, generating food activity media objects (FAMO) on said one or more recording device with permission granted or recording devices of associated consumers with allowed permissions, receiving at the provider of food management services FAMOs from said one or more recording device of the registered consumer recording at the provider of food management services of at least part of the FAMOs as associated with the unique identifier, communicating receipt of FAMOs from the provider of food management services to one or more of the one or more recording device of the registered consumer or the recording devices of associated consumers, and generating a database by the provider of food management services of individual and aggregated consumer activity, wherein the individual consumer activity includes the FAMOs that are recorded.

In an aspect, the invention relates to a computer implemented method for associating consumers with similar food goals. The method includes identifying a set of common food activities (SCFA) in a computer system, establishing an aggregation minimum grade threshold (AMGT) in the computer system, identifying a consumer that has graded said SCFA and whose grade of said SCFA exceed said AMGT in the computer system, identifying one or more other consumers that have graded said SCFA and given a grade of said SCFA that are substantially similar to grades given by the consumer for the SCFA in the computer system, and estimating how the consumer would grade a food activity in the computer system that the consumer has not yet graded by determining a similarity between the SCFA and the food activity that the consumer has not yet graded, wherein determining the similarity between the SCFA and the food activity that the consumer has not yet graded includes comparing the grade given by the one or more other consumers for the SCFA to grade given by the one or more other consumers for the food activity that the consumer has not yet graded.

### BRIEF DESCRIPTION OF THE DRAWINGS

The following detailed description of the preferred embodiments of the present invention will be better understood when read in conjunction with the appended drawings. For the purpose of illustrating the invention, there are shown in the drawings embodiments that are presently preferred. It is understood, however, that the invention is not limited to the precise arrangements and instrumentalities shown.

FIG. 1 illustrates a user specified kitchen diary. This kitchen diary can be reached on a PC, tablet, or mobile phone.

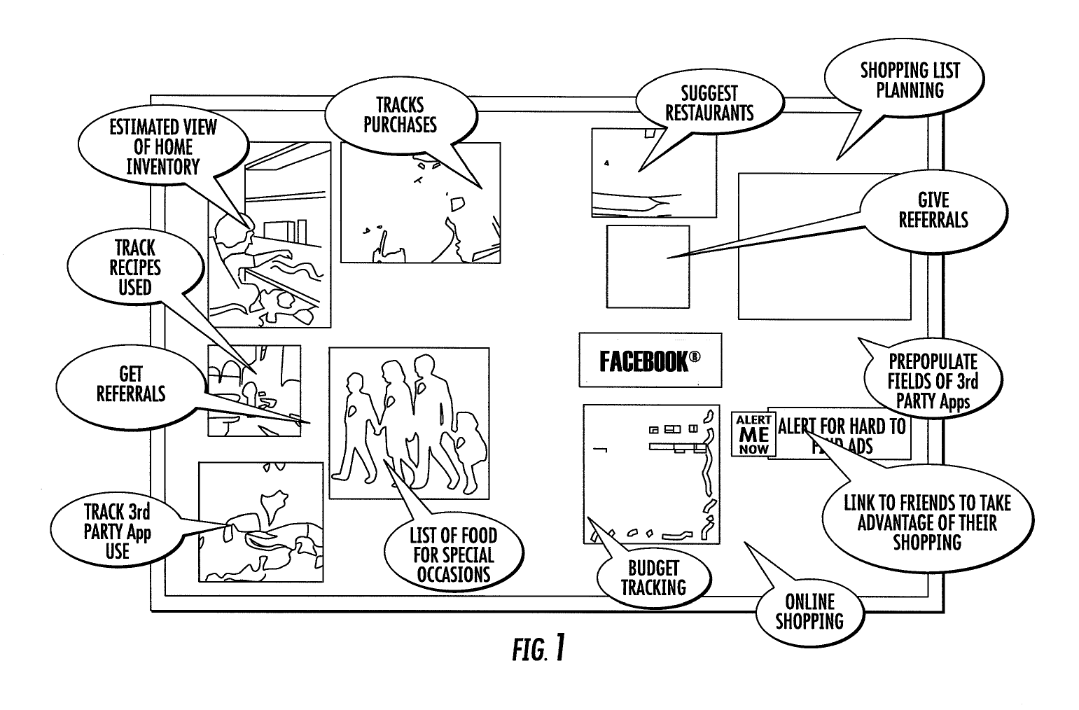

FIG. 2 illustrates a personal food assistant operating within a smart phone coordinating with a consumer kitchen diary, along with a kitchen diaries analysis computer (KDAC) performing analysis on the FAMOs stored in their respective kitchen diaries to provide services.

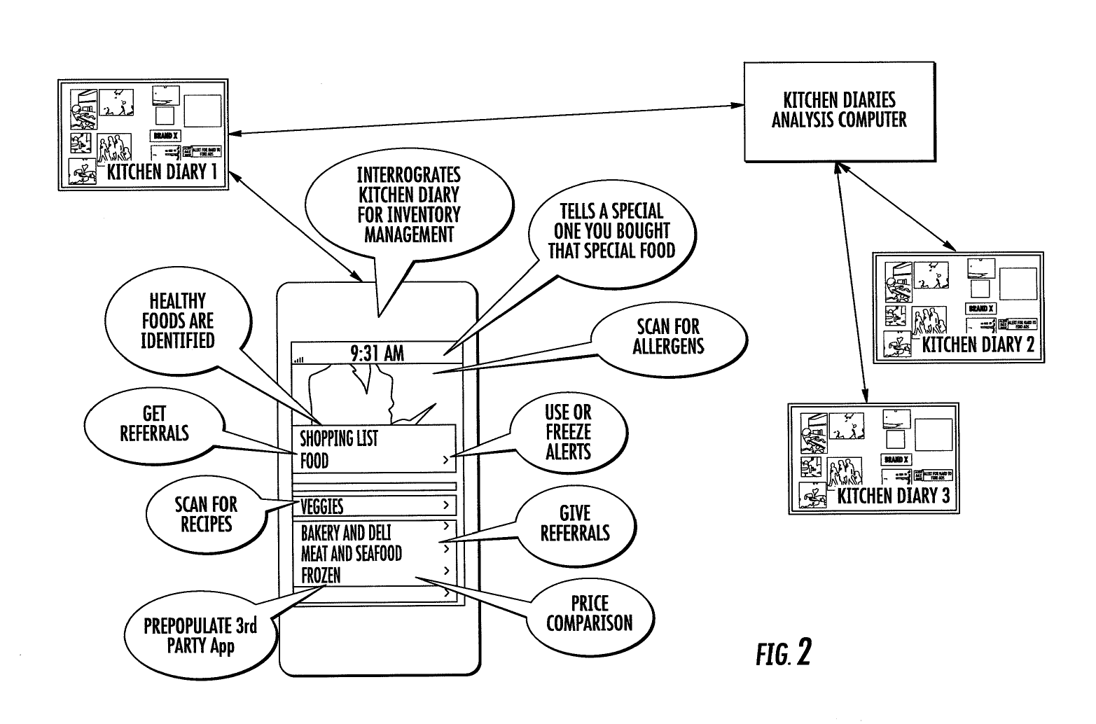

### DETAILED DESCRIPTION OF THE PREFERRED EMBODIMENTS

Certain terminology is used in the following description for convenience only and is not limiting. The words “right,” “left,” “top,” and “bottom” designate directions in the drawings to which reference is made. As used herein, “connected” means that elements within the system are connected physically or through a remote connection such that they are functionally connected. This connection can be temporary or permanent. As a non-limiting example, a remote connection may be through a localized Radio Frequency link. The words “a” and “one,” as used in the claims and in the corresponding portions of the specification, are defined as including one or more of the referenced item unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof.

Embodiments include a system and methods for managing, supporting and empowering consumers to manage their food experience in an enhanced manner to achieve as many of their sometimes concurrent, and sometimes overlapping objectives as possible, while living within the limits of medically, culturally or life-style imposed restrictions. The present application remedies the shortcomings of the prior art by enabling consumers to control key elements of their overall food procurement and consumption experience while maintaining privacy over their actions and controlling how third parties share and utilize their personal food-related information. This allows the development of specialized websites and mobile applications, thereby allowing a much greater expression of intimacy and relevance for the consumer, and creating a more focused market target for service providers.

Embodiments include a method of providing food management services. Food management services may collectively include one or more of food tracking, food budgeting, diet compliance, shopping choices, access to third parties, and/or waste services. The method for providing food management services may include offering one or more incentives for prospective consumers to register with a provider of food management services, receiving a request at the provider of food management services from a consumer to register with the provider of food management services to receive at least one of the offered incentives, registering the consumer with the food management provider of services, assigning a unique identifier to the registered consumer, assigning permission granted to one or more recording devices of the registered consumer that is connected to a network to record food activity activities of the registered consumer using the unique identifier at the provider of food management services, enabling one or more applications on said registered consumer's recording device to generate unique transaction identifiers to record food activity information of the registered consumer, generating food activity media objects (FAMO) on said recording devices with granted permissions or recording devices of associated consumers with allowed permissions, receiving at the provider of food management services FAMOs from one or more of the registered consumer's recording devices, recording at the provider of food management services of at least part of the FAMOs as associated with the unique identifier, communicating receipt of FAMOs from the provider of food management services to one or more of the registered consumer's recording device or recording devices of associated consumers, and generating a database by the provider of food management services of individual, and aggregated consumer activity, wherein the individual consumer activity includes the FAMOs that are recorded.

Registering the consumer may include receiving consumer-specific information about the consumer. The consumer-specific information may include information about consumer-specific information about the consumer's family and social network. Consumer-specific information may include diet restrictions, food restrictions, ingredient restrictions, additive restrictions, diet framework, diet plan, food selection restrictions, food preferences, cross-contamination information, cross-contamination feedback, budgetary guidelines, loyalty programs, serendipity guidelines. Consumer-specific information may include restrictions on the use of information by the provider of the food management service.

The method may also include receiving at the provider of food management services FAMOs from one or more additional registered consumer's recording devices prior to the step of recording at least part of the FAMOs associated with the unique identifier.

FAMOs may be generated by events including but not limited to consumer interaction, interaction with expert, referral generation, referral management, package scanning, picture taking, audio recording, video recording, item scanning, nutrient checking, caloric ratio estimation, estimated glycemic load/index computation, search for recipe, modification of recipe, response to query from food providers, response to query from food service management services provider, advice from independent agents, advice from agents affiliated with food management service provider, advice from agents registered with food management service provider, expiration of timer, date of food activities, reading of referrals, generation of referrals, location of food activities, food ratings, rating of recipes, and rating of food activities. FAMOs may include offers of third parties to registered consumers and the possible disposition thereof. The possible disposition includes but is not limited to acceptance, rejection, acknowledgment of receipt, forwarding of, sharing, posting on a social network, inclusion in a blog, inclusion in a wiki, assigning a like/dislike, assigning a tag, assigning a hashtag, assigning a metatag, inclusion in a activity timeline, and inclusion in a list.

Embodiments include a computer implemented method for associating consumers with similar food goals. The method may include identifying a set of common food activities (SCFA) in a computer system, establishing an aggregation minimum grade threshold (AMGT) in the computer system, identifying a consumer that has graded said SCFA and whose grade of said SCFA exceed said AMGT in the computer system, identifying one or more other consumers that have graded said SCFA and given a grade of said SCFA that is substantially similar to grades given by the consumer for the SCFA in the computer system, and estimating how the consumer would grade a food activity in the computer system that the consumer has not yet graded by determining a similarity between the SCFA and the food activity that the consumer has not yet graded, wherein determining the similarity between the SCFA and the food activity that the consumer has not yet graded includes comparing the grade given by the one or more other consumers for the SCFA to grade given by the one or more other consumers for the food activity that the consumer has not yet graded.

Food activities may include but are not limited to searching for recipes, altering them to accommodate for specific goals or based on available inventory, shopping, verifying information about nutritional content, eating at a restaurant, alerting others about the availability of specific food items, cooking, taking pictures of meals or dishes, counting calories, trying a new food item, providing feedback and referral, rating food or activities.

The grade of SCFA may be a function of consumer ratings, number of referrals, number of likes, number of uses, number of purchases, and/or proportion of purchases. The grade of SCFA may be a function of food restrictions, ingredient restrictions, compliance with religious regulations, organic nature, processing restrictions, brand restrictions, and/or country of origin restrictions.

Common food activities managed by this invention may include but are not limited to searching for recipes, altering them to accommodate specific goals or available food inventory (e.g. pantry stock), shopping, verifying information about nutrition, compliant dining at a restaurant (e.g. optimized compliance with food restrictions and/or preferences), alerting others about the availability of specific food items, cooking, taking pictures of meals or dishes, counting calories, mapping nutritional components, purchasing food online, auto/assisted replenishment/shopping, trying a new food item, and providing feedback, referral, or rating said activities. Rating food activities can be as simple as, but not limited to, choosing a like/don't like binary value, assigning a color or shape or setting a numeric grade.

Increasingly, these activities occur in a mobile environment using web-connected smartphones.

In an embodiment, the consumer manages his food activities using a kitchen diary that integrates input from multiple sources and activities. Those sources capture shopping information using; for instance, the XML based digital receipt structure of the Association for Retail Technology Standards, or using database-to-database transfers. It may also be obtained by taking or scanning of shopping receipts and performing optical character recognition of items followed by insertion of simple descriptions. Capturing recipes from the web is also provided, along with the ability to change them according to consumer choices. An important source of data about food activity is captured when the consumer scans specific food items, whether for nutritional content, seeking pricing information, asking for a coupon/discount, or seeking a recipe.

In another embodiment, the consumer sets and manages a series of food goals that are quantifiable performance measures. These include but are not limited to calorie intake, calories distributed among fat and non fat product, amount of salt consumed, number of times take out food is ordered, amount of food being wasted, budget allocated to food or specific stores.

In one embodiment, the kitchen diary comprises software running on a computer. In another embodiment, the kitchen diary is hosted by a remote computer, aka in the cloud. In either case, the kitchen diary can synch up and communicate with a smartphone.

In another embodiment, software operating on the kitchen diary data allows the estimation of the current food levels of key foodstuff. This can then be turned into a shopping list or to prepopulate third party applications that assist consumers when shopping, providing filters for “healthy” foods, managing food restrictions, ingredient restrictions, compliance with religious regulations, organic nature, processing restrictions, brand restrictions, and country of origin restrictions,

In another embodiment, the consumer enters preference, and restrictions such as diets and/or ingredient to filter reports and/or queries. A nice preference is keeping track of food special to specific members of the family. This can be used to trigger reminders of purchasing those at special occasions such as birthdays, etc. These reminders can be performed while on the go.

In another embodiment, the kitchen diary keeps track of past expenses and assist budget future expenses, and filters according to store, food type, rebate levels, offers, amount purchases, and preferences.

In another embodiment, mobile applications are integrated with the kitchen diary by providing the facility to prepopulate key fields and report activity and data activity back to the kitchen diary.

In another embodiment, the consumer uses a smartphone with a smartphone application providing the linkage and intelligence to act as his or her personal food assistant to channel multiple aspects of the food activities compliant with goals and restrictions.

In another embodiment, changes in the consumer activities are detected to propose new services or new foods. To facilitate the exchange of information and allow a distributed promotional system, information may be encoded in a manner that allows data encapsulation. Methods from web 2.0 (such as but not limited to JSON, JSONP, JSON-RPC, SOAP, REST, XML-RPC) can readily be used to create these Food Activity Media Objects.

An advantage of this standardization of information about food activity is the ability to leverage the experience of specific consumers to help others. Analyzing food activities by a set of consumers who share similar traits or who rate their activities in a similar manner, providing information on food cross contamination based on recurrences of issue reports, recommendation for new products or recommendations for new recipes.

### Embodiment List

The following list includes particular embodiments. The list, however, is not limiting and does not exclude alternate embodiments otherwise described or as would be appreciated by one of ordinary skill in the art.

1. A method of providing food management services comprising:

offering one or more incentives for prospective consumers to register with a provider of food management services;

receiving a request at the provider of food management services from a consumer to register with the provider of food management services to receive at least one of the offered incentives;

registering the consumer with the food management provider of services to create a registered consumer;

assigning a unique identifier to the registered consumer;

assigning permission granted to one or more recording devices of the registered consumer that is connected to a network to record food activities of the registered consumer using the unique identifier at the provider of food management services;

enabling one or more applications on said one or more recording devices of the registered consumer to generate unique transaction identifiers to record food activity information of the registered consumer;

generating food activity media objects (FAMO) on said recording devices with permission granted or recording devices of associated consumers with allowed permissions;

receiving at the provider of food management services FAMOs from one or more of the one or more recording devices of the registered consumer;

recording at the provider of food management services of at least part of the FAMOs as associated with the unique identifier;

communicating receipt of FAMOs from the provider of food management services to one or more of the one or more recording devices of the registered consumer or recording devices of associated consumers; and

generating a database by the provider of food management services of individual, and aggregated consumer activity, wherein the individual consumer activity includes the FAMOs that are recorded.

2. The method of embodiment 1, wherein registering the consumer includes receiving consumer-specific information about the consumer.

3. The method of any one or more of embodiments 1-2 further comprising receiving at the provider of food management services FAMOs from one or more additional registered consumer's recording devices prior to the step of recording at least part of the FAMOs associated with the unique identifier.

4. The method of any one or more of embodiments 2-3, wherein the consumer-specific information includes information about the consumer's family and social network.

5. The method of any one or more of embodiments 2-4, wherein the consumer-specific information includes one of more of the following: diet restrictions, food restrictions, ingredient restrictions, additive restrictions, diet framework, diet plan, food selection restrictions, food preferences, cross-contamination information, cross-contamination feedback, budgetary guidelines, loyalty programs, serendipity guidelines.

6. The method of any one or more of embodiments 2-5, wherein the consumer-specific information includes restrictions on the use of information by provider of food management service.

7. The method of any one or more of embodiments 1-6, wherein the FAMOs are generated by events selected from the group consisting of: consumer interaction, interaction with expert, referral generation, referral management, package scanning, picture taking, audio recording, video recording, item scanning, nutrient checking, caloric ratio estimation, estimated glycemic load/index computation, search for recipe, modification of recipe, response to query from food providers, response to query from food service management services provider, advice from independent agents, advice from agents affiliated with food management service provider, advice from agents registered with food management service provider, expiration of timer, date of food activities, reading of referrals, generation of referrals, location of food activities, food ratings, rating of recipes, and rating of food activities.

8. The method of any one or more of embodiments 1-7, wherein the FAMOs include offers of third parties to the registered consumer and the possible disposition thereof.

9. The method of embodiment 8, wherein the possible disposition includes acceptance, rejection, acknowledgment of receipt, forwarding of, sharing, posting on a social network, inclusion in a blog, inclusion in a wiki, assigning a like/dislike, assigning a tag, assigning a hashtag, assigning a metatag, inclusion in a activity timeline, or inclusion in a list.

10. A computer-implemented method for associating consumers with similar food goals the method comprising:

identifying a set of common food activities (SOFA) in a computer system;

establishing an aggregation minimum grade threshold (AMGT) in the computer system;

identifying a consumer that has graded said SCFA and whose grade of said SCFA exceeds said AMGT in the computer system;

identifying one or more other consumers that have graded said SCFA and given a grade of said SCFA that is substantially similar to grades given by the consumer for the SCFA in the computer system; and

estimating how the consumer would grade a food activity in the computer system that the consumer has not yet graded by determining a similarity between the SCFA and the food activity that the consumer has not yet graded, wherein determining the similarity between the SCFA and the food activity that the consumer has not yet graded includes comparing the grade given by the one or more other consumers for the SCFA to a grade given by the one or more other consumers for the food activity that the consumer has not yet graded.

11. The computer-implemented method of embodiment 10, wherein the food activity includes one or more of the following: searching for recipes, altering recipes to accommodate for specific goals or based on available inventory, shopping, verifying information about nutritional content, eating at a restaurant, alerting others about the availability of specific food items, cooking, taking pictures of meals or dishes, counting calories, trying a new food item, providing feedback and referral, rating food or activities.

12. The computer-implemented method of any one or more of embodiments 10-11, wherein the grade of SCFA of the consumer and the grade of SCFA of one or more other consumers are a function of at least one of more of the following: consumer ratings, number of referrals, number of likes, number of uses, number of purchases, proportion of purchases.

13. The computer-implemented method of any one or more of embodiments 10-12, wherein the grade of SCFA of the consumer and the grade of SCFA of one or more other consumers are a function of at least one or more of the following: food restrictions, ingredient restrictions, compliance with religious regulations, organic nature, processing restrictions, brand restrictions, and country of origin restrictions.

The skilled artisan will readily appreciate that the methods and systems herein may be implemented with multiple consumers, multiple prospective consumers, and/or multiple registered consumers.

The methods herein may be implemented on myriad types of devices and/or combinations of devices. Combinations of devices may be functionally connected by physical or wireless connections as known in the art. A device may include a processor, a memory device, a communication interface, a data storage device, and a display, which may be a touchscreen display. These components may be connected via a system bus in the device, and/or via other appropriate interfaces within the device.

The memory device may be or include a device such as a Dynamic Random Access Memory (D-RAM), Static RAM (S-RAM), or other RAM or a flash memory.

The data storage device may be or include a hard disk, a magneto-optical medium, an optical medium such as a CD-ROM, a digital versatile disk (DVDs), or Blu-Ray disc (BD), or other type of device for electronic data storage. The data storage device may store instructions that define the application, and/or data that is used by the application.

The communication interface may be, for example, a communications port, a wired transceiver, a wireless transceiver, and/or a network card. The communication interface may be capable of communicating using technologies such as Ethernet, fiber optics, microwave, xDSL (Digital Subscriber Line), Wireless Local Area Network (WLAN) technology, wireless cellular technology, and/or any other appropriate technology.

The touchscreen display may be based on one or more technologies such as resistive touschreen technology, surface acoustic wave technology, surface capacitave technology, projected capacitave technology, and/or any other appropriate touchscreen technology.

When the touchscreen receives data that indicates user (e.g., a consumer, prospective consumer, or registered consumer) input, the touchscreen may provide data to an application implementing at least a portion of a method herein.

The application may be loaded into the memory device. Although actions are described herein as being performed by the application, this is done for ease of description and it should be understood that these actions are actually performed by the processor (in conjunction with a persistent storage device, network interface, memory, and/or peripheral device interface) in the device, according to instructions defined in the application. The instructions may be stored on a computer readable medium. Alternatively or additionally, the memory device and/or the data storage device in the device may store instructions which, when executed by the processor, cause the processor to perform any feature or any combination of features described above as performed by the application. Alternatively or additionally, the memory device and/or the data storage device in the device may store instructions which, when executed by the processor, cause the processor to perform (in conjunction with the memory device, communication interface, data storage device, and/or the display, which may be a touchscreen display) any feature or any combination of features described above as performed by the application.

The device may be, for example, an Apple iPad, an Apple iPhone, any other smartphone, or any other appropriate computing device. The application may run on an operating system such as iOS, Android, Linux, Windows, and/or any other appropriate operating system.

As used herein, the term “processor” broadly refers to and is not limited to a single- or multi-core central processing unit (CPU), a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

The features described herein may also be implemented, mutatis mutandis, on a desktop computer, a laptop computer, a netbook, a cellular phone, a personal digital assistant (PDA), or any other appropriate type of computing device or data processing device.

Although features and elements are described above in particular combinations, each feature or element can be used alone or in any combination with or without the other features and elements. For example, each feature or element as described above may be used alone without the other features and elements or in various combinations with or without other features and elements. Sub-elements of the methods and features described above may be performed in any arbitrary order (including concurrently), in any combination or sub-combination.

Further embodiments herein may be formed by supplementing an embodiment with one or more element from any one or more other embodiment herein, and/or substituting one or more element from one embodiment with one or more element from one or more other embodiment herein.

It is understood, therefore, that this invention is not limited to the particular embodiments disclosed, but is intended to cover all modifications which are within the spirit and scope of the invention as defined by the appended claims; the above description; and/or shown in the attached drawings.

What is claimed is:

1. A method of providing food management services comprising:
offering one or more incentives for prospective consumers to register with a provider of food management services;
receiving a request at the provider of food management services from a consumer to register with the provider of food management services to receive at least one of the offered incentives;
registering the consumer with the food management provider of services to create a registered consumer;
assigning a unique identifier to the registered consumer;
assigning permission granted to one or more recording devices of the registered consumer that is connected to a network to record food activities of the registered consumer using the unique identifier at the provider of food management services;
enabling one or more applications on said one or more recording devices of the registered consumer to generate unique transaction identifiers to record food activity information of the registered consumer;
generating food activity media objects (FAMO) on said recording devices with permission granted or recording devices of associated consumers with allowed permissions;
receiving at the provider of food management services FAMOs from one or more of the one or more recording devices of the registered consumer;
recording at the provider of food management services of at least part of the FAMOs as associated with the unique identifier;
communicating receipt of FAMOs from the provider of food management services to one or more of the one or more recording devices of the registered consumer or recording devices of associated consumers; and
generating a database by the provider of food management services of individual, and aggregated consumer activity, wherein the individual consumer activity includes the FAMOs that are recorded.

2. The method of claim 1, wherein registering the consumer includes receiving consumer-specific information about the consumer.

3. The method of claim 2, wherein the consumer-specific information further includes information about the consumer's family and social network.

4. The method of claim 2, wherein the consumer-specific information includes one of more of the following: diet restrictions, food restrictions, ingredient restrictions, additive restrictions, diet framework, diet plan, food selection restrictions, food preferences, cross-contamination information, cross-contamination feedback, budgetary guidelines, loyalty programs, serendipity guidelines.

5. The method of claim 2, wherein the consumer-specific information includes restrictions on the use of information by provider of food management service.

6. The method of claim 1 further comprising receiving at the provider of food management services FAMOs from one or more additional registered consumer's recording devices prior to the step of recording at least part of the FAMOs associated with the unique identifier.

7. The method of claim 1, wherein the FAMOs are generated by events selected from the group consisting of: consumer interaction, interaction with expert, referral generation, referral management, package scanning, picture taking, audio recording, video recording, item scanning, nutrient checking, caloric ratio estimation, estimated glycemic load/index computation, search for recipe, modification of recipe, response to query from food providers, response to query from food service management services provider, advice from independent agents, advice from agents affiliated with food management service provider, advice from agents registered with food management service provider, expiration of timer, date of food activities, reading of referrals, generation of referrals, location of food activities, food ratings, rating of recipes, and rating of food activities.

8. The method of claim 1, wherein the FAMOs include offers of third parties to the registered consumer and the possible disposition thereof.

9. A computer-implemented method for associating consumers with similar food goals the method comprising:
identifying a set of common food activities (SCFA) in a computer system;
establishing an aggregation minimum grade threshold (AMGT) in the computer system;
identifying a consumer that has graded said SCFA and whose grade of said SCFA exceeds said AMGT in the computer system;
identifying one or more other consumers that have graded said SCFA and given a grade of said SCFA that is substantially similar to grades given by the consumer for the SCFA in the computer system; and
estimating how the consumer would grade a food activity in the computer system that the consumer has not yet graded by determining a similarity between the SCFA and the food activity that the consumer has not yet graded, wherein determining the similarity between the SCFA and the food activity that the consumer has not yet graded includes comparing the grade given by the one or more other consumers for the SCFA to a grade given by the one or more other consumers for the food activity that the consumer has not yet graded.

10. The computer-implemented method of claim 9, wherein food the activity includes one or more of the following: searching for recipes, altering recipes to accommodate for specific goals or based on available inventory, shopping, verifying information about nutritional content, eating at a restaurant, alerting others about the availability of specific food items, cooking, taking pictures of meals or dishes, counting calories, trying a new food item, providing feedback and referral, rating food or activities.

11. The computer-implemented method of claim 9, wherein the grade of SCFA of the consumer and the grade of SCFA of the one or more other consumers are a function of at least one of more of the following: consumer ratings, number of referrals, number of likes, number of uses, number of purchases, proportion of purchases.

12. The computer-implemented method of claim 9, wherein the grade of SCFA of the consumer and the grade of SCFA of the one or more other consumers are a function of at least one or more of the following: food restrictions, ingredient restrictions, compliance with religious regulations, organic nature, processing restrictions, brand restrictions, and country of origin restrictions.
